(19) United States
(12) Patent Application Publication
(10) Pub. No.: US 2026/0051741 A1
(43) Pub. Date: Feb. 19, 2026

(54) MULTI-OPERATIONAL ENERGY STORAGE SYSTEMS

(71) Applicant: NOMAD TRANSPORTABLE POWER SYSTEMS, INC., Waterbury, VT (US)

(72) Inventors: Christopher Andrew MCKAY, Waterbury Center, VT (US); Gregg Richard NOBLE, Saxtons River, VT (US)

(73) Assignee: NOMAD TRANSPORTABLE POWER SYSTEMS, INC., Waterbury, VT (US)

(21) Appl. No.: 19/103,513

(22) PCT Filed: Aug. 11, 2023
(86) PCT No.: PCT/US2023/072093

§ 371 Date: Feb. 12, 2025

Related U.S. Application Data
(60) Provisional application No. 63/371,317, filed on Aug. 12, 2022.

(51) Int. Cl. H02J 3/32; H02J 3/00

(52) U.S. Cl. CPC H02J 3/32; H02J 3/001

(57) ABSTRACT

An example of an apparatus to connect to a utility-scale power distribution network is provided. The apparatus includes a first energy storage unit to store a first amount of energy at a utility-scale to be provided to a power distribution network. Also, the apparatus includes a first inverter to connect the first energy storage unit to the power distribution network. The apparatus further includes a second energy storage unit to store a second amount of energy at the utility-scale to be provided to the power distribution network. The apparatus also includes a second inverter to connect the second energy storage unit to the power distribution network. Furthermore, the apparatus includes a switch disposed between the first energy storage unit and the second energy storage unit, wherein the switch converts the first energy storage unit and the second energy storage unit between a line interactive state and an online state.

### CROSS-REFERENCE TO RELATED APPLICATIONS

This application claims priority to U.S. Application Ser. No. 63/371,317, filed Aug. 12, 2022, which is hereby incorporated by reference in its entirety.

### BACKGROUND

Electricity and the delivery of electricity is an important part in industrial development, economic development, and for personal use in daily life. Electricity may be generated to supply a power system or power grid. The demands or loads on the power grid may fluctuate through time, such as throughout the day or over longer periods of time. For example, air conditioning energy demands may increase the amount of demand for electricity. While the demand for electricity increases, the supply of electricity may be able to be increased beyond a limit. Accordingly, energy sources, such as generating stations are typically designed to provide the peak electricity demanded. When the demand exceeds this amount, the power system may not be able to maintain the specified power resulting in brownouts or blackouts. Energy storage devices connected to a power network can be used to provide energy when the demand for electricity exceeds the power provided by the energy source. In such situations the energy storage device may provide an uninterruptible power source (UPS) to reduce brownouts or blackouts across a power network.

There are generally two different types of topologies for UPS systems. The first topology is a line interactive system where the energy storage unit UPS maintains the inverter in line between a power source (such as a utility electric grid or a generator) and the power network (as referred to as the protected loads). The power network may be fed directly from the power source or isolated from the power source and fed directly from the inverter using the batteries. The inverter provides two-directional current flow and directs current from the energy source to the energy storage unit when operating normally where the energy source can provide excess power above the demand of the power network. When the power source cannot provide sufficient power to the power network, the inverter switches current direction to provide power to the power network to allow for the voltage and power in the power network to be maintained. An isolation switch separates the energy storage unit and the protected power network from the primary power source.

The second topology is an online system where the energy storage unit is placed in series between the power source and the power network. In this topology, the energy storage unit sits between inverters and current is converted from alternating current from the power source to charge the energy storage unit. The current from the energy storage unit is then converted from direct current back to alternating current to supply the power network. In the online topology, the current flows in the same direction and if the power source does not provide sufficient power to the power network by itself, the energy storage unit provides the demanded power.

### SUMMARY

In accordance with an aspect of the invention, there is provided an apparatus. The apparatus includes a first energy storage unit to store energy at a utility-scale to be provided to a power distribution network. In addition, the apparatus includes a first inverter to connect the first energy storage unit to the power distribution network. Furthermore, the apparatus includes a second energy storage unit to store energy at the utility-scale to be provided to the power distribution network. The apparatus also includes a second inverter to connect the second energy storage unit to the power distribution network. The apparatus further includes a switch disposed between the first energy storage unit and the second energy storage unit. The switch converts the first energy storage unit and the second energy storage unit from a line interactive state to an online state.

The switch may be open in the line interactive state. The first inverter and the second inverter may be connected to the power distribution network in parallel in the line interactive state. The switch may be closed in the online state. The first inverter may be connected to a power source of the power distribution network and the second inverter may be connected to a load of the power distribution network in the online state.

The power distribution network may be a public power grid. The power distribution network may be a closed power grid. The first energy storage unit may receive energy from the power distribution network to charge the first energy storage unit. The second energy storage unit may receive energy from the power distribution network to charge the second energy storage unit. The switch may be controlled remotely.

The first energy storage unit may have a capacity of at least 1.2 megawatt-hours. The capacity may be at least 2.4 megawatt-hours.

In accordance with an aspect of the invention, there is provided a method. The apparatus includes storing energy in a plurality of energy storage units. In addition, the method involves connecting the energy storage units to a power distribution network. Furthermore, the method involves converting the energy storage units from operating in a line interactive state to an online state.

### BRIEF DESCRIPTION OF THE DRAWINGS

Reference will now be made, by way of example only, to the accompanying drawings in which:

FIG. 1 is a schematic representation of an example of an apparatus that may be connected to a power network in a line interactive state;

FIG. 2 is a schematic representation of an example of an apparatus to provide an uninterruptible power source in an online state;

FIG. 3 is a schematic representation a system using the apparatus shown in FIG. 1 to connect a power distribution network in a line interactive topology;

FIG. 4 is a schematic representation a system using the apparatus shown in FIG. 2 to connect a power distribution network in an online topology; and

FIG. 5 is a flowchart of an example of a method converting the apparatus shown in FIGS. 1 and 2 from a line interactive state to an online state.

### DETAILED DESCRIPTION

The demand for electricity may often fluctuate to create imbalances between power generation and power consumption. In particular, instantaneous demand for electrical energy is often unpredictable from day to day and may depend on various factors such as temperature, industrial manufacturing changes, and seasonal variations. Since electricity storage is generally not used, the variations may result in challenges to the power network in terms of electricity generation and distribution. To address this issue, a utility-scale energy storage system may be installed in the power distribution network, such as a power grid, to convert and store electricity from an energy source, such as a generator, and to subsequently convert it back into electrical energy to be re-supplied into the power distribution network. In some examples, additional electrical energy above the generation rate of power distribution network may be provided during peak demand periods. During these periods, an energy storage system that has been pre-charged with energy may supplement the electricity supplied in the power distribution network.

It is to be appreciated by a person of skill with the benefit of this description that energy storage systems operating on the utility-scale are significantly different from other energy storage systems operating on a small scale, such as the use of utility-scale transformers, relays, circuit breakers, metering and other grid interconnection equipment required by utilities to protect a power grid. In particular, energy storage systems connected to three-phase grids use controls, monitoring, and protection that may not be required on smaller single-phase circuits to manage the potential for import or export from the energy storage system on to the electric grid. Furthermore, regulatory or contractual restrictions may call for power flow that is compliant with grid codes and contractual obligations. Larger energy storage systems will also generally use a direct current bus that is typically about 400V to 1500V, which is much higher than typical smaller systems. It is to be appreciated by a person of skill with the benefit of this description that these voltage levels call for protection and controls that may not be typical of smaller systems. Additionally, larger systems have higher current ratings and require different safety and protection devices when carrying currents at about 100 Amps to 2000 Amps.

The manner by which the energy storage systems are implemented is not particularly limited and they may be used in a line interactive state to support the grid, protect loads, or perform grid services or as an online uninterruptible power source system. Each system has advantages and disadvantages over the other where some applications may benefit from a line interactive and other applications may benefit from an online uninterruptible power source system. In general, a line interactive design is easier to install in a power distribution network since it can be connected in parallel. In addition, a line interactive protected load does not use a double inverter which means that it can operate with fewer components and provide comparable protection from power failures, power sags, power surges, and carrying voltages. In contrast, with an online uninterruptible power source system, a failure or insufficiency of the energy source for the load can be supplemented or transferred to battery power with no transfer time. In the event of a power failure at the energy source, that part of the circuit simply drops out while the energy storage unit continues to provide power.

An apparatus is provided to deliver a utility-scale energy storage unit to different locations that may act to protect a load for a power distribution network or augment capabilities within that part of the network. A load may be protected by minimizing variations in the delivery of power such as by providing peak shaving in some instances. In particular, the apparatus is adaptable to different topologies and may be operated as part of a line interactive protected load or as an online uninterruptible power source system. The conversion between the two topologies may be carried out manually, such as with a switch, or may be controlled automatically with a controller receiving signals from a control panel or remotely. The apparatus may also be mounted on a transportation system, such as a trailer, to provide mobility, It is to be appreciated by a person of skill with the benefit of this description that since the energy storage unit may be deployed to multiple sites, the apparatus may convert easily between using the energy storage unit as part of a line interactive system or an online uninterruptible power source system without using additional components to increase the number of applications for which the energy storage unit may be used.

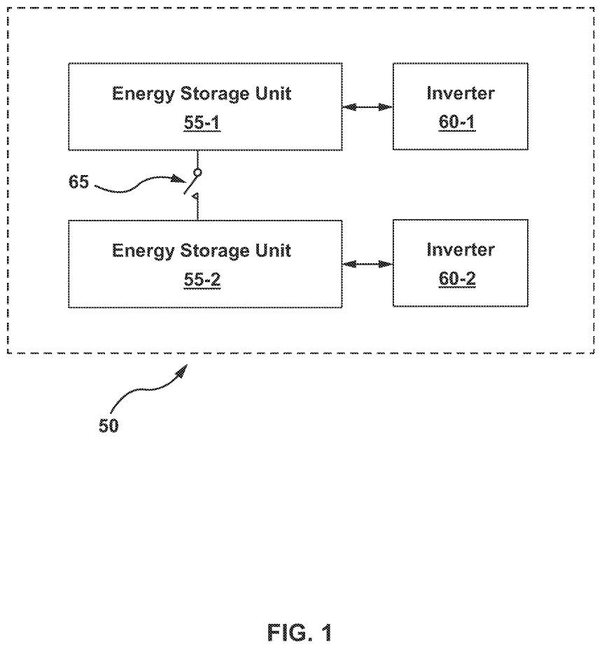

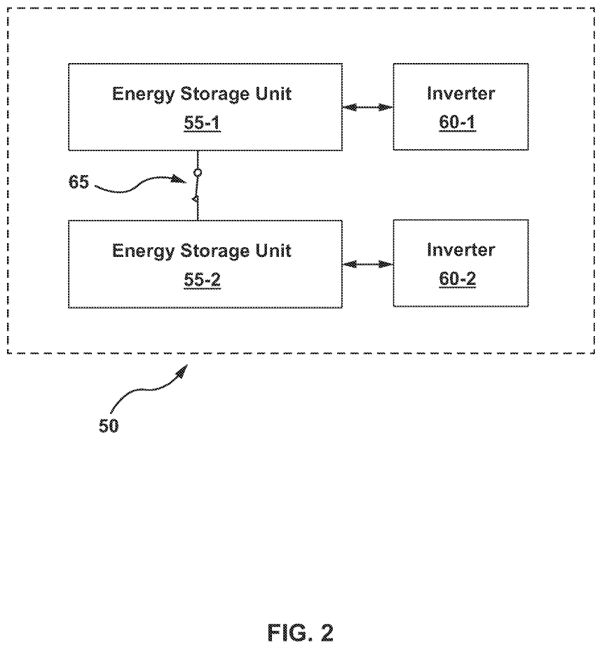

Referring to FIGS. 1 and 2, an apparatus to provide energy storage capacity to protect a load operating in different topologies is generally shown at 50. It is to be appreciated by a person of skill with the benefit of this description that the apparatus 50 may include additional components, such as control systems, docking mechanisms, and other devices to move the energy storage units and to connect the energy storage units to the various points of interconnections. In the present example, the apparatus 50 includes energy storage units 55-1, 55-2 (generically, these energy storage units are referred to herein as “energy storage unit 55” and collectively they are referred to as “energy storage units 55”), inverters 60-1, 60-2 (generically, these inverters are referred to herein as “inverter 60” and collectively they are referred to as “inverters 60”), and a switch 65.

In the present example, the energy storage units 55 are to store energy at a utility-scale to provide a power distribution network with electric power. For example, the energy storage units 55 may connect to a docking station (not shown) via a standardized interconnection interface. The manner by which the energy storage units 55 are connected to the power distribution network is not limited. For example, the energy storage units may be connected and disconnected to a power distribution network using various circuitry depending on the topology of the power distribution network as discussed in further detail below.

The energy storage units 55 are not particularly limited and may be modified to accommodate a wide variety of applications. In the present example, the energy storage unit 55-1 is substantially similar to the energy storage unit 55-2. In some examples, the energy storage units 55 may be within the same mobile platform or trailer. In other examples, each energy storage unit 55 along with an inverter 60 may be separate trailers where the energy storage units 55 are connected together. The energy storage units 55 provide utility-scale energy storage with a capacity of over 1.2 megawatt-hours. In other examples, the energy storage units 55 may provide a storage capacity of 2.4 megawatt-hours. In addition, the energy storage units 55 may provide electricity at a high peak power to meet demands of the power distribution network or during a power failure. For example, the energy storage units 55 may discharge power at up to 500 kilowatts in some examples. In other examples, the energy storage units 55 may discharge power at higher rates of up to about 1 megawatt.

In the present example, the energy storage units 55 include a plurality of lithium-ion batteries. For example, an energy storage unit 55 may include six 17 module racks of KORE MARK 1 lithium-ion batteries. As another example, the energy storage unit 55 may include twelve 17 modules racks of KORE MARK 1 lithium-ion batteries. Other examples may include over twenty 17 module racks of KORE MARK 1 lithium-ion batteries.

It is to be appreciated by a person of skill with the benefit of this description that the types of battery cells or other storage devices used by the energy storage units 55 are not particularly limited. In particular, other types of battery cells capable of providing the physical and electrical characteristics may be used. In particular, in order to operate at the utility-scale, each energy storage unit 55 may have a high capacity and high discharge rate. In this regard, other types of battery cells or capacitors may be suitable to provide electricity at a sufficient rate during peak demand or store sufficient energy for a predetermined volume occupied by the battery cells to be useful.

The inverters 60 are to connect the energy storage units 55 to the power distribution network. In the present example, the inverters 60 in the present example can be used to convert direct current to alternating current as well as to convert alternating current to direct current. Accordingly, the inverters 60 may be used to charge the energy storage units 55 by receiving alternating current from the power distribution network and converting it to direct current to charge the energy storage units 55. Therefore, excess power generated by the power distribution network above the load of the power distribution network may be used to provide energy to each energy storage unit 55 for charging. Each inverter 60 may also be used to supply power to the power distribution network by converting direct current from the energy storage units 55 to alternating current to supplement the power when the energy source of the power distribution network does not output sufficient power.

The switch 65 is disposed between the energy storage unit 55-1 and the energy storage unit 55-2. In the present example, the switch is to toggle an electrical connection between the energy storage unit 55-1 and the energy storage unit 55-2 to allow for the energy storage units 55 to operate in a line interactive state or an online state. The manner by which the switch 65 is toggled is not particularly limited. For example, the switch 65 may be a mechanical connection that is manually toggled from an open state to break the electrical connection between the energy storage unit 55-1 and the energy storage unit 55-2 to a closed state to form an electrical connection between the energy storage unit 55-1 and the energy storage unit 55-2. In other examples, the switch 65 may be an electrical switch that may be controlled via an instrument panel or remotely controlled over a network. In further examples, the apparatus 50 may include sensors to detect the connection of the apparatus 50 to the power distribution network to automatically control the switch 65.

The energy storage unit 55-1 and the energy storage unit 55-2 may operate in a line interactive state when the switch 65 is open as shown in FIG. 1. In particular, the energy storage unit 55-1 and the energy storage unit 55-2 may act as independent power supplies connected in parallel to the power distribution network. In this example, the inverters 60 may receive alternating current from the power distribution network to charge the energy storage units 55. When the power distribution network is to draw power from the energy storage units 55, the current flow through the inverters 60 is reversed and the inverters are to convert direct current from the energy storage units 55 to the alternating current to supply the power distribution network.

The energy storage unit 55-1 and the energy storage unit 55-2 may operate in an online state when the switch 65 is closed as shown in FIG. 2. In particular, the energy storage unit 55-1 and the energy storage unit 55-2 are connected in series and may act as single power supply connected in series between an energy source of the power distribution network and the load of the power distribution network. In this example, the inverter 60-1 may receive alternating current from an energy source of the power distribution network, such as a public power grid, to charge the energy storage units 55. When the load of the power distribution network exceeds the power from the energy source, the energy storage units provide additional current to the inverter 60-2 to be supplied to the load of the power distribution network.

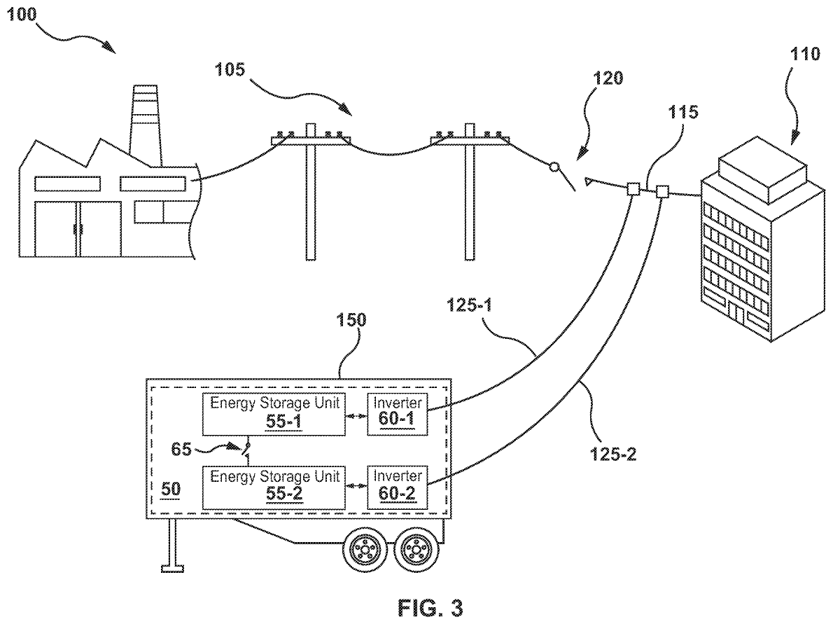

Referring to FIG. 3, an example of a system 100 using the apparatus 50 to connect a power distribution network is generally shown. It is to be appreciated by a person of skill with the benefit of this description that the power distribution network is not particularly limited. For example, the power distribution network may be a public power grid in some examples. In other examples, the power distribution network may be a closed network separated from a public network, such as a power grid at a remote location. In the present example, the energy source 105 is not particularly limited and may be a general public power grid. In other examples the energy source 105 may be a power generation station. The load 110 is also not particularly limited. In the present example shown, the load 110 is a building. In other examples, the load 110 may be any customer load that is to be protected. The systems 100 includes an energy source 105, a load 110, a transmission line 115, an islanding switch 120, and connectors 125-1 and 125-2 (generically, these energy storage units are referred to herein as “connector 125” and collectively they are referred to as “connectors 125”).

In the present example, the apparatus 50 is mounted on a mobile platform 150 such that it can be moved from one location to another. In the present example, the apparatus 50 is connected to the power distribution network in a line interactive topology. The switch 65 is open and the energy storage units 55 are each connected to the load 110 separately and in parallel to provide power when the power provided by the energy source 105 is not sufficient to meet the demand from the load 110.

The transmission line 115 is not particularly limited and may be any suitable conducting cable used to carry current from the energy source 105 to the load 110. For example, the transmission line 115 may be a high voltage line carrying current across large distances. In this example, the inverters 60 are configured to handle the high voltages of long distance transmission lines. In other examples, the transmission line 115 may be a delivery line from a transformer station to a building.

In the present example, the system also includes an islanding switch 120 to separate the load 110 from the energy source 105. For example, if the energy source 105 does not provide sufficient power, the islanding switch 120 may be opened and the apparatus 50 may operate as a power supply. The islanding switch 120 is not particularly limited and may be a manual switch to be opened by a user, such as when an alarm is activated, or it may be an automatically operated when certain thresholds are passed. In some examples, if the islanding switch 120 is operated automatically and sufficiently fast, the apparatus 50 may operate as a line interactive uninterruptible power source.

The connectors 125 are to connect the apparatus 50 to the transmission line 115. In the present example, the connector 125-1 is to connect the inverter 60-1 to the transmission line 115. Similarly, the connector 125-2 is to connect the inverter 60-2 to the transmission line 115. The manner by which the connector 125 connects to the transmission line 115 is not particularly limited. For example, to connector 125 may mate with a docking station (not shown) installed on the transmission line 115. In other examples, the connector 125 may tap directly onto the transmission line 115.

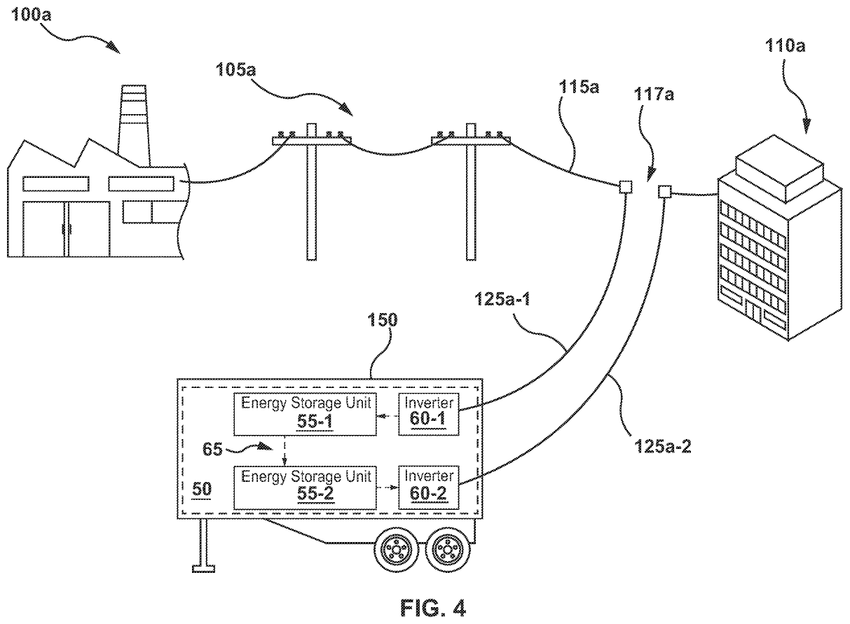

Referring to FIG. 4, another example of a system 100a using the apparatus 50 to connect a power distribution network is generally shown. Like components of the system 100a bear like reference to their counterparts in the system 100, except followed by the suffix “a”. It is to be appreciated by a person of skill with the benefit of this description that system 100a is not limited and may include additional components. The system 100a includes an energy source 105a, a load 110a, a transmission line 115a, and connectors 125a-1 and 125a-2 (generically, these energy storage units are referred to herein as “connector 125a” and collectively they are referred to as “connectors 125a”).

In the present example, the apparatus 50 is also mounted on the mobile platform 150 such that it can be moved from one location to another. In particular, the apparatus 50 and the mobile platform 150 may be a unit that is was previously connected to the system 100 in the line interactive topology. In the present example, the apparatus 50 is connected to the power distribution network in an online topology. The switch 65 is closed. The energy storage units 55 are combined via the switch 65 and connected to power distribution network in series on the transmission line 115a between the energy source 105a and the load 110a such that current flows through the apparatus 50 via a double conversion from alternating current to direct current at the inverter 60-1 and from direct current to alternating current at the inverter 60-2. Since current passes through the apparatus 50, the energy storage units 55 can provide any shortfall of power from the energy source 105a during periods of high demand from the load 110a to provide continuous clean power. In particular, it is to be appreciated by a person of skill with the benefit of this description that a drop in current from the energy source 105a would not be noticeable at the load 110a. Furthermore, if the energy source 105a fails completely, the energy storage units 55 may continue operating uninterrupted as the apparatus 50 has no islanding switch to prevent current draw from the failed energy source 105a.

The connectors 125a are to connect the apparatus 50 to the transmission line 115a. In the present example, the apparatus 50 is to connect to the transmission line 115a in series. Accordingly, the transmission line 115a is separated into two portions with a break 117a. The break 117a is not particularly limited and in some examples, the break 117a may be provided with a switch that may be opened or closed such that the system 100a may be switched between the line interactive topology and the online uninterruptible power source topology. The connector 125a-1 is to connect the inverter 60a-1 to the portion of transmission line 115a connected to the energy source 105a. The connector 125a-2 is to connect the inverter 60-2 to the portion of the transmission line 115a connected to the load 110a. The manner by which the connector 125a connects to the transmission line 115a is not particularly limited. For example, the connector 125a may mate with a docking station (not shown) installed on the transmission line 115a that separates the transmission line 115a between the energy source 105a and the load 110a.

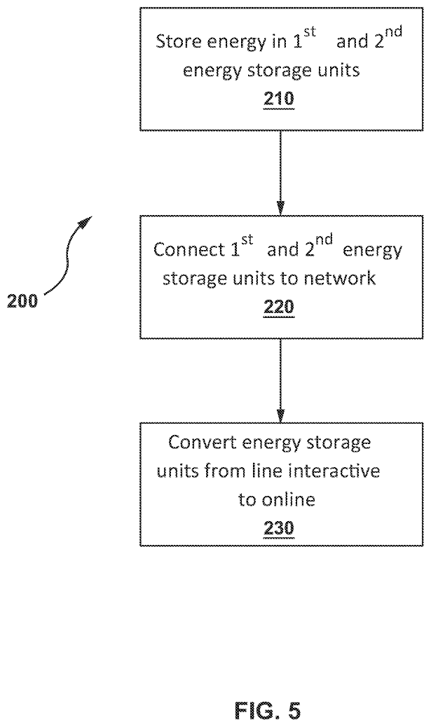

Referring to FIG. 5, a flowchart of a method of converting an apparatus 50 from operating in a line interactive topology to an online topology to protect a load is generally shown at 200. In order to assist in the explanation of method 200, it will be assumed that method 200 may be performed by the apparatus 50. Indeed, the method 200 may be one way in which the apparatus 50 may be operated. Furthermore, the following discussion of method 200 may lead to a further understanding of the apparatus 50 and its components. In addition, it is to be emphasized, that method 200 may not be performed in the exact sequence as shown, and various blocks may be performed in parallel rather than in sequence, or in a different sequence altogether.

Beginning at block 210, energy is to be stored in the energy storage units 55. The manner by which the energy storage units 55 receive energy for storage is not particularly limited. For example, the energy storage units 55 may be charged at a charging station and moved to the location where the apparatus 50 is to be installed. The energy storage units 55 are then connected to the power distribution network at block 220 to a protected load. In other examples, the energy may be received from the power distribution network to add energy to the energy storage units 55 during operation. Accordingly, in this example, the order of block 220 may be reversed with block 210.

The energy storage units 55 may then be converted from a line interactive state to an online state at block 230 depending on the application via the switch 65. It is to be appreciated that the energy storage units 55 may be converted back to the line interactive state when the application changes, such as moving the apparatus 50 to a different power distribution network.

Various advantages will now become apparent to a person of skill with the benefit of this description. In particular, the apparatus 50 provides load protector capable of conversion between two different topologies without significant replacement of components or reconfiguration of the existing components. Accordingly, the apparatus 50 may be adaptable to multiple topologies and when mounted on a mobile platform 150, the apparatus 50 may be used by at multiple sites with different topologies. The allows for users to utilize the benefits of an energy storage platforms during a defined period of time, such as for a lease period, to protect a load on a power distribution network and to increase the robustness of the network. For example, a region susceptible to seasonal power outages or peak demand due to weather may install the apparatus for a period of time to reduce the chances of blackouts or brownouts. During other times, the apparatus 50 may be moved to another location. Accordingly, capital expenditures, insurance, electrical carrying costs, and maintenance may be shared by multiple users at different locations subject to different network load cycles.

It should be recognized that features and aspects of the various examples provided above may be combined into further examples that also fall within the scope of the present disclosure.

1. An apparatus comprising:
a first energy storage unit to store a first amount of energy at a utility-scale to be provided to a power distribution network;
a first inverter to connect the first energy storage unit to the power distribution network;
a second energy storage unit to store a second amount of energy at the utility-scale to be provided to the power distribution network;
a second inverter to connect the second energy storage unit to the power distribution network; and
a switch disposed between the first energy storage unit and the second energy storage unit, wherein the switch converts the first energy storage unit and the second energy storage unit between a line interactive state and an online state.

2. The apparatus of claim 1, wherein the switch is open in the line interactive state.

3. The apparatus of claim 2, wherein the first inverter and the second inverter are connected to the power distribution network in parallel.

4. The apparatus of claim 1, wherein the switch is closed in the online state.

5. The apparatus of claim 4, wherein the first inverter is connected to a power source of the power distribution network and the second inverter is connected to a load of the power distribution network in the online state.

6-7. (canceled)

8. The apparatus of claim 1, wherein the first energy storage unit receives energy from the power distribution network to charge the first energy storage unit.

9. The apparatus of claim 1, wherein the second energy storage unit receives energy from the power distribution network to charge the second energy storage unit.

10-11. (canceled)

12. The apparatus of claim 1, wherein the first energy storage unit has a capacity is of at least 2.4 megawatt-hours.

13. A system comprising:
an energy source;
a transmission line to carry a current from the energy source to a load;
a mobile energy storage apparatus comprising:
a first energy storage unit to store energy at a utility-scale to be provided to the load;
a first inverter to connect the first energy storage unit to the load via the transmission line;
a second energy storage unit to store energy at the utility-scale to be provided to the load;
a second inverter to connect the second energy storage unit to the load via the transmission line; and
a switch disposed between the first energy storage unit and the second energy storage unit, wherein the switch converts the mobile energy storage apparatus between a line interactive state and an online state; and
a connector to connect the mobile energy storage apparatus to the transmission line, wherein the mobile energy storage apparatus is to supplement the current to the load from the energy source.

14. The system of claim 13, wherein the switch is open in the line interactive state, and wherein the connector comprises a first port to connect the first inverter to the transmission line and a second port to connect the second inverter to the transmission line.

15. The system of claim 14, wherein the first port and the second port are connected to the transmission line in parallel.

16. The system of claim 13, wherein the switch is closed in the online state, and wherein the connector comprises a first port and a second port to connect the mobile energy storage apparatus to the transmission line in series.

17-18. (canceled)

19. A method comprising:
storing a first amount of energy at a utility-scale in a first energy storage unit;
storing a second amount of energy at the utility-scale in a second energy storage unit, wherein the first amount of energy and the second amount of energy are to be provided to a power distribution network;
connecting the first energy storage unit to the power distribution network via a first inverter;
connecting the second energy storage unit to the power distribution network via a second inverter; and
converting the first energy storage unit and the second energy storage unit between a line interactive state and an online state with a switch connecting the first energy storage unit and the second energy storage unit.

20. The method of claim 19, wherein converting to the line interactive state comprises opening the switch.

21. The method of claim 19, further comprising connecting the first inverter and the second inverter to the power distribution network in parallel in the line interactive state.

22. The method of claim 19, wherein converting to the online state comprises closing the switch.

23. The method of claim 19, further comprising connecting the first inverter to the power distribution network and the second inverter to a load of the power distribution network in the online state.

24. The method of claim 19, further comprising charging the first energy storage unit with the power distribution network.

25. The method of claim 19, further comprising charging the second energy storage unit with the power distribution network.

26. The method of claim 19, further comprising controlling the switch remotely.
